(19) United States
(12) Patent Application Publication
(10) Pub. No.: US 2024/0426315 A1
(43) Pub. Date: Dec. 26, 2024

(54) BLOWER WITH TOROIDAL FAN BLADES

(71) Applicant: Milwaukee Electric Tool Corporation, Brookfield, WI (US)

(72) Inventor: Joseph Wilinski, Brookfield, WI (US)

(21) Appl. No.: 18/743,484

(22) Filed: Jun. 14, 2024

Related U.S. Application Data
(60) Provisional application No. 63/522,272, filed on Jun. 21, 2023.

(51) Int. Cl. F04D 29/38; F04D 19/00; F04D 25/06; F04D 29/32; F04D 29/52

(52) U.S. Cl. CPC F04D 29/384; F04D 19/002; F04D 25/0673; F04D 29/325; F04D 29/522

(57) ABSTRACT

A blower having a fan with toroidal shaped blades is provided. The blower includes an air inlet, an air outlet, and a fan assembly disposed between the air inlet and the air outlet. The fan assembly comprises a fan having a hub and a plurality of blades extending from the hub. Each blade has a root and a tip end. The root extends from the hub and the tip end extends to the hub or to an adjacent blade.

### CROSS-REFERENCE TO RELATED APPLICATIONS

The present application claims priority to U.S. Provisional Patent Application No. 63/522,272 filed on Jun. 21, 2023, the disclosure of which is incorporated by reference herein in its entirety.

### FIELD

The present disclosure relates generally to an outdoor tool such as a blower, and more particularly, to a blower having a toroidal fan.

### BACKGROUND

Outdoor tools such as blowers are commonly used to concentrate debris, e.g., leaves, using a blowing function. Blowers being powered by a battery power source are particularly desirable due to their portability. However, optimization of the efficiency of a blower is necessary to improve runtime of the blower while maintaining performance, i.e., airflow rate, of the blower. Moreover, blowers are traditionally very loud, which can be disruptive to users and nearby persons.

Accordingly, improved blower tools are desired in the art. In particular, a blower which provides optimized efficiency and reduced noise would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a blower is provided. The blower includes an air inlet, an air outlet, and a fan assembly disposed between the air inlet and the air outlet. The fan assembly comprises a fan having a hub and a plurality of blades extending from the hub. Each blade has a root and a tip end. The root extends from the hub and the tip end extends to the hub or to an adjacent blade.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a side view of a blower in accordance with embodiments of the present disclosure;

FIG. 2 is a partial side cross-sectional view of a blower including an airflow generating assembly in accordance with embodiments of the present disclosure;

FIG. 3A is a front view of an axial fan in accordance with embodiments of the present disclosure;

FIG. 3B is a front view of an embodiment of an axial fan in accordance with embodiments of the present disclosure; and

FIG. 4 is a perspective view of a blower in accordance with other embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a blower, such as a handheld blower or a backpack blower for outdoor use, having an axial fan with toroidal shaped fan blades. The axial fan with toroidal shaped fan blades has improved airflow generating efficiency and reduced noise as compared to traditional blowers.

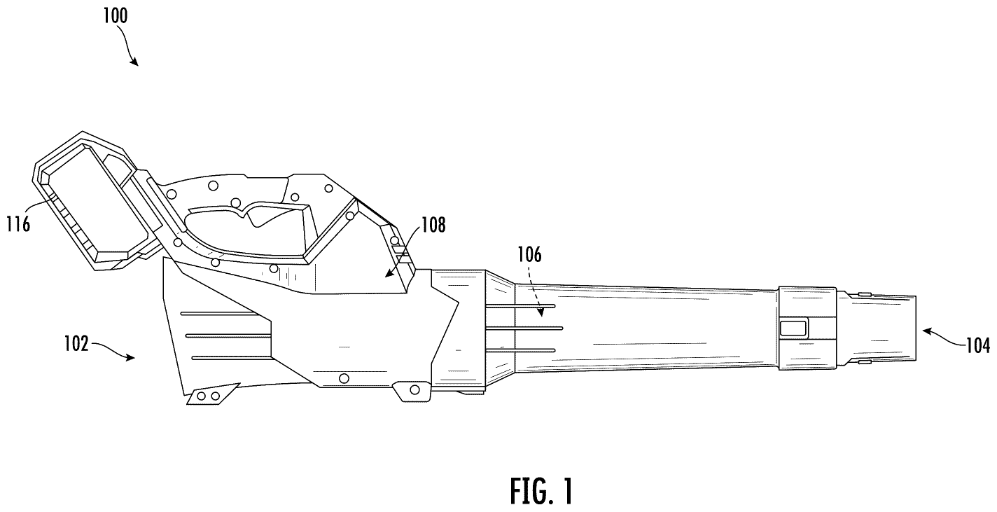

Referring now to the drawings, FIG. 1 illustrates a side view of a blower 100 in accordance with an exemplary embodiment. The blower 100 is configured to generate airflow along an airflow conduit 106 extending between an air inlet 102 and an air outlet 104 of the blower 100. The airflow generating conduit 106 may include a blower tube as shown.

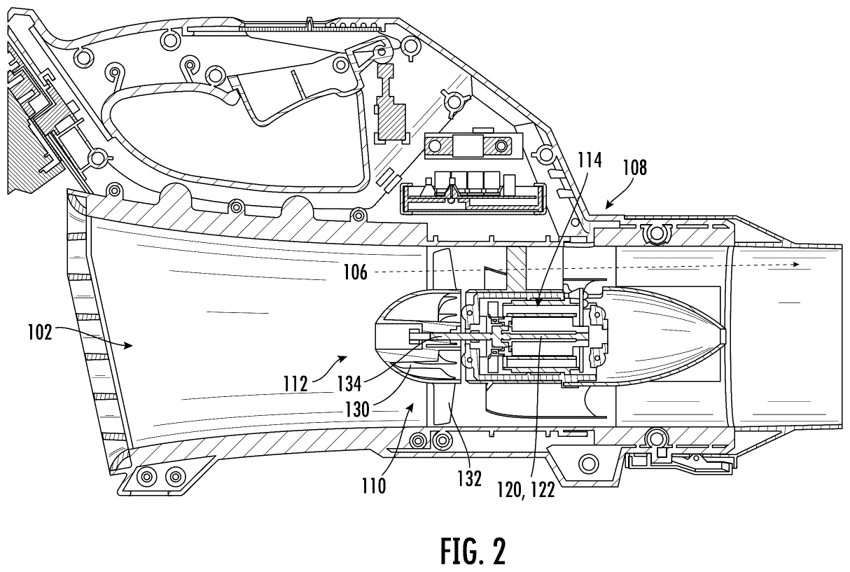

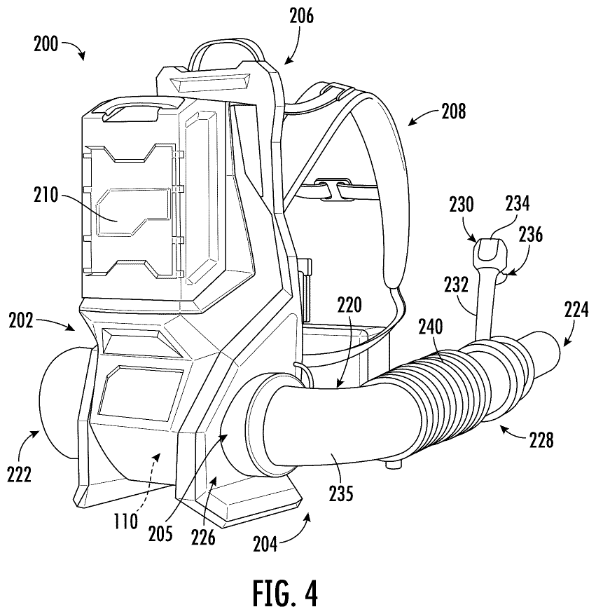

As illustrated in FIGS. 1 and 2, a blower housing 108 may at least partially enclose components of the blower 100 such as an airflow generation assembly 110 including a fan 112 and a motor 114 that drives the fan 112, as well as various other components. Power to operate the airflow generation assembly 110 may be provided by a suitable power source such as one or more batteries 116 removably coupled to the blower housing 108. As shown, the blower 100 may be provided as a standard handheld blower having a cordless battery powered power source (e.g. batter(ies) 116). In other embodiments, the blower may include a corded electric power source and/or a gas power source. Alternatively, a blower of the present invention may be provided as a backpack blower (as illustrated in FIG. 4 and discussed herein) adapted to be worn on a user's back and, for example, having a cordless battery power source.

Still referring to FIGS. 1 and 2, the airflow generation assembly 110 may have an axial configuration including an axial fan 112. The motor 114 may be mounted within the housing 108. For instance, the blower housing 108 may include a motor mount 118 configured to support the motor 114 between the air inlet 102 and the air outlet 104. The motor 114 is oriented along a motor axis 120. The motor axis 120 coincides with a central axis of the airflow conduit. Rotation of the motor 114 causes rotation of a primary motor shaft 122 extending along the motor axis 120. The motor shaft 122 is coupled to the fan 112. In this manner, rotation of the motor shaft 122 causes rotation of the fan 112.

The fan 112 includes a hub 130 and a plurality of blades 132. The hub 130 may have a generally circular cross-sectional shape and may extend along the motor axis 120. The motor shaft 122 is coupled to the hub 130 and/or a fan drive shaft 134 to enable transmission of rotation from the motor 120 to the hub 130 or the fan drive shaft 134 and ultimately to the blades 132.

The blades 132 extend radially away from the hub 130. Each blade 132 extends from a root 140 to a tip end 142 and has a first face 144 and a second face 146 opposite the first face 144. The root 140 contacts the hub 130 of the fan 112. The tip end 142 contacts the hub 130 at a different angular position around the circumference of the hub 130 than the root 140. In another embodiment, the tip end 142 may contact an adjacent blade 132 of the fan 112.

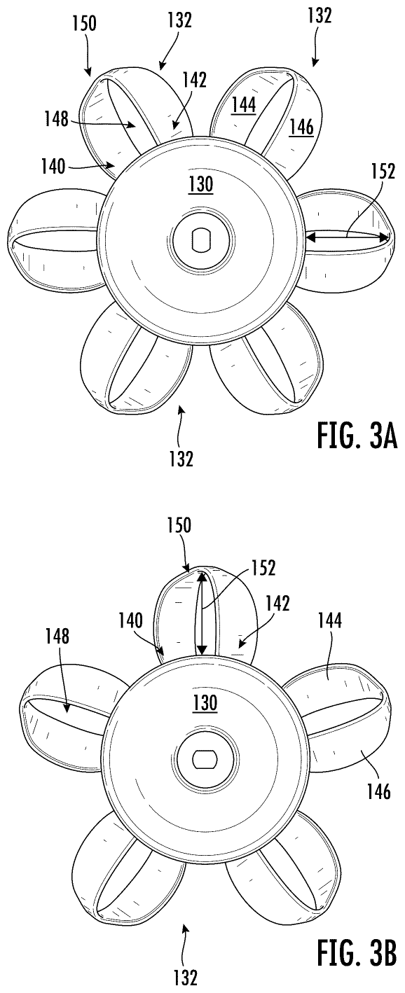

In this regard, and as illustrated in FIGS. 3A-3B, one or more of the blades 132 of the fan 112 may have a toroid or toroidal shape. In other words, the blade 132 may form a surface of a revolution with a hole 148 or opening in the middle. The hole 148 or opening may be surrounded by the first face 144 of the blade 132, and the first face 144 may be directed inward toward an axis of revolution and surrounding the hole 148. The second face 146 may be directed outward from the fan 112 away from the hole 148. The blade 132 may have a single inflection point 150 at which the blade 132 changes direction and curves back toward the hub 130 of the fan. Each blade 132 may have a maximum radial distance 152 extending between the hub 130 and the inflection point 150.

As shown in FIGS. 3A-3B, the fan 112 may have a plurality of blades 132. For instance, FIG. 3A illustrates a fan 112 having six blades 132 equally angularly spaced about the circumference of the hub 130. FIG. 3B illustrates a fan 112 having five blades 132 equally angularly spaced about the circumference of the hub 130. Regardless of the number of blades 132, each of the blades 132 may have equal angular spacing about the circumference of the hub 130.

The root 140 and the tip end 142 of each blade 132 are angularly spaced apart about the circumference of the hub 130. In other words, the root 140 and the tip end 142 of each blade 132 do not coincide with each other or extend from a same point of the hub 130 of the fan 112.

The axial fan 112 having toroidal shaped blades 132 of the present invention has improved efficiency of generating and moving air from the air intake 102 to the air outlet 104. As a result, the blower 100 may generate higher velocity airflow delivered from the air outlet 104, and as a result, increased efficiency of moving debris.

Because each blade 132 includes two points of contact, e.g., with the hub 130 at the root 140 and with the hub 130 or an adjacent blade 132 at the tip end 142, the toroidal shaped design of each blade 132 may have increased stiffness than a traditional axial fan blade extending from a hub to a free end and having only a single point of contact.

The fan of the present invention having toroidal shaped blades 132 generates less acoustic noise, e.g., lower decibel noise, than a blower having a traditional axial fan blade extending from a hub to a free end and having only a single point of contact.

Referring now to FIG. 4 and as discussed above, in some embodiments the blower is a backpack blower 200. In these embodiments, the blower 200 includes a main body 202 and a blower unit 204. Main body 202 may include a frame 206 and straps 208, and may be configured to be worn on a user's back. A motor may be disposed within the main body 202 or the blower unit 204. Additionally, a power source 210 may be removably coupled to the blower tool 200 and configured to supply power to the motor. For example, the power source 210 may include one or more batteries removably coupled to a portion of the blower tool 200, such as to the main body 202 (e.g. the frame 206 thereof). In other example embodiments, the blower tool 200 may include a corded electric power source and/or a gas power source.

In at least one example embodiment, the blower unit 204 includes an air duct 220 extending from an air inlet 222 to an air outlet 224. The air duct 220 may be formed by an air duct body 226 and a blower tube 228. For example, the air duct body 226 may define the air inlet 222 at one end thereof. The air duct body 226 may be coupled, directly or indirectly, with the blower tube 228 at an opposite end relative to the air inlet 222. For example, an elbow tube 235 may be provided between the air duct body 226 and the blower tube 228. In some example embodiments, a bellows 240 may be provided between the air duct body 226 and the blower tube 228, e.g., to enable the blower tube 228 to pivotably move and/or rotate relative to the air duct body 226.

The blower unit 204 may also include a handle 230. The handle 230 may be coupled to the blower tube 228 such that a user may grip the handle 230 to move and/or rotate the blower tube 228 relative to the air duct body 226. The handle 230 may be coupled to the blower tube 228 adjacent the air outlet 224. For example, the handle 230 may be positioned between the bellows 240 and the air outlet 224 of the blower tube 228. Additionally, the handle 230 may include a base portion 232 extending from the blower tube 228 and an end portion 234 coupled to the base portion 232 opposite the blower tube 228. A user may grip the handle 230 during operation of the blower tool 200 at the base portion 232 and/or the end portion 234. A trigger 236, which may be in communication with the motor and operable to actuate the motor, may be provided on the handle 230.

It should be understood that blower 200 may include an airflow generation assembly 110 and/or other features as discussed above with respect to FIGS. 1, 2, 3A, and 3B, such as in a housing 205 defined by the air duct and/or other components of the main body 202 or blower unit 204.

Further aspects of the invention are provided by one or more of the following embodiments:

A blower comprising: an air inlet; an air outlet; and a fan assembly disposed between the air inlet and the air outlet, wherein the fan assembly comprises a fan, the fan comprising a hub and a plurality of blades extending from the hub, each blade comprising a root and a tip end, wherein the root extends from the hub and the tip end extends to the hub or to an adjacent blade.

The blower of any one or more of the embodiments, wherein each blade has a toroidal shape.

The blower of any one or more of the embodiments, wherein each blade surrounds an opening formed between the root, the tip end, and the hub.

The blower of any one or more of the embodiments, wherein each blade comprises a first face and a second face opposite the first face, wherein the first face is directed inward toward the opening and the second face is directed outward away from the opening.

The blower of any one or more of the embodiments, wherein each blade comprises a single inflection point between the root and the tip end.

The blower of any one or more of the embodiments, wherein the inflection point is disposed at a maximum radial distance from the hub to the blade.

The blower of any one or more of the embodiments, wherein the fan is an axial fan.

The blower of any one or more of the embodiments, wherein the fan assembly is disposed within a housing, the blower further including a motor disposed within the housing and a power source electrically coupled to the motor removably coupled to the housing, the power source being at least one battery.

The blower of any one or more of the embodiments, wherein the housing is part of a handheld blower.

The blower of any one or more of the embodiments, wherein the housing is part of a backpack blower configured to be worn on a user's back.

An apparatus as shown and described in one or more of the embodiments herein.

A system configured to operate in accordance with any one or more of the embodiments disclosed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A blower comprising:
an air inlet;
an air outlet; and
a fan assembly disposed between the air inlet and the air outlet, wherein the fan assembly comprises a fan,
the fan comprising a hub and a plurality of blades extending from the hub, each blade comprising a root and a tip end, wherein the root extends from the hub and the tip end extends to the hub or to an adjacent blade.

2. The blower of claim 1, wherein each blade has a toroidal shape.

3. The blower of claim 1, wherein each blade surrounds an opening formed between the root, the tip end, and the hub.

4. The blower of claim 3, wherein each blade comprises a first face and a second face opposite the first face, wherein the first face is directed inward toward the opening and the second face is directed outward away from the opening.

5. The blower of claim 1, wherein each blade comprises a single inflection point between the root and the tip end.

6. The blower of claim 5, wherein the inflection point is disposed at a maximum radial distance from the hub to the blade.

7. The blower of claim 1, wherein the fan is an axial fan.

8. The blower of claim 1, wherein the fan assembly is disposed within a housing, the blower further including a motor disposed within the housing and a power source electrically coupled to the motor removably coupled to the housing, the power source being at least one battery.

9. The blower of claim 8, wherein the housing is part of a handheld blower.

10. The blower of claim 8, wherein the housing is part of a backpack blower configured to be worn on a user's back.
